(19) United States
(12) Patent Application Publication
(10) Pub. No.: US 2025/0364814 A1
(43) Pub. Date: Nov. 27, 2025

(54) EXTENDED CELL BALANCING USING TELEMATICS

(71) Applicant: Caterpillar Inc., Peoria, IL (US)

(72) Inventors: Michael David SMITH, Cambridgeshire (GB); James Kieran MCCLOSKEY, Cambridgeshire (GB); Mahadevan UNNIKRISHNAN, Bangalore (IN); Benjamin TABATOWSKI-BUSH, Saline, MI (US)

(73) Assignee: Caterpillar Inc., Peoria, IL (US)

(21) Appl. No.: 18/674,369

(22) Filed: May 24, 2024

(51) Int. Cl. H02J 7/00

(52) U.S. Cl. CPC H02J 7/00032; H02J 7/0014

(57) ABSTRACT

In some implementations, a battery management unit (BMU) may command a balancing controller to perform a first cell balancing operation on one or more battery cells in a battery pack. The BMU may output, to a telematics controller, a wake-up time interval. The BMU may receive a wake-up command at an end of the wake-up time interval to wake the BMU from a sleep state. The BMU may command the balancing controller to perform a second cell balancing operation as a result of receiving the wake-up command.

### TECHNICAL FIELD

The present disclosure relates generally to batteries and, for example, to performing multiple cell balancing operations on one or more battery cells.

### BACKGROUND

“Cell balancing” refers to the process of equalizing the charge across multiple cells in a battery pack. Battery packs are typically made up of multiple cells connected in series or parallel configurations to meet voltage and capacity demands. Over time, due to differences in cell manufacturing, usage patterns, and environmental conditions, the charge levels across individual battery cells can diverge. Some cells may become overcharged while others may be undercharged, leading to an imbalance. Imbalances between battery cells can reduce the overall performance and capacity of the battery pack and, in some cases, may lead to premature failure of individual cells. Cell balancing can correct such imbalances by either redistributing the charge from higher charged cells to lower charged ones or by ensuring that all cells are charged and discharged at the same rate.

In some battery modules, specialized controllers (generally referred to herein as “balancing controllers” or “battery monitoring integrated circuits (BMICs)”) perform the cell balancing operation. Balancing controllers, however, can have certain limitations, depending on how they are used with battery packs. For example, balancing controllers may be hardcoded to time out after a certain time limit (e.g., 2 hours), and that time limit may not be sufficient for the balancing controllers to complete the cell balancing operation, particularly for larger battery packs.

China Patent Application Publication No. 113968165 (the '165 publication) discloses a battery control method, a device, control equipment and an automobile, wherein the control method is applied to a battery management system (BMS) and comprises the following steps: receiving a battery balancing instruction sent by an intelligent vehicle-mounted terminal T-box; according to the battery balancing instruction, carrying out balance judgment on the battery cell of the battery at intervals of first preset time; when the judgment result is unbalanced, judging whether the current finished automobile meets the balance condition; and when the whole vehicle meets the balance condition, performing balance control on the battery cell, and stopping the balance control until the judgment result is balance. According to the '165 publication, the active equalization control is started at a regular time for the battery, so that the voltage of each cell of the battery is kept within a certain difference value, and the self-maintenance of the battery is realized; the safety of the vehicle during the balance control is ensured by setting the balance condition; the BMS can synthesize the voltage of each battery cell, and can start or stop active equalization control, thereby prolonging the service life of the battery.

The BMS of the present disclosure solves one or more of the problems set forth above and/or other problems in the art.

### SUMMARY

A method may include commanding a balancing controller to perform a first cell balancing operation on one or more battery cells in a battery pack; outputting, to a telematics controller, a wake-up time interval; receiving, at a battery management unit (BMU), a wake-up command at an end of the wake-up time interval to wake the BMU from a sleep state; and commanding the balancing controller to perform a second cell balancing operation as a result of receiving the wake-up command.

A machine may include a plurality of battery packs, each having a plurality of battery cells; a telematics controller configured to output a wake-up command after a wake-up time interval; and a balancing controller configured to perform a first cell balancing operation on one or more of the plurality of battery cells of one or more of the plurality of battery packs and to perform a second cell balancing operation as a result of the telematics controller outputting the wake-up command.

A BMU may include one or more memories; and one or more processors, communicatively coupled to the one or more memories, configured to: command a balancing controller to perform a first cell balancing operation on one or more battery cells in a battery pack; set a wake-up time interval; enter a sleep state; receive a wake-up command at an end of the wake-up time interval; and command the balancing controller to perform a second cell balancing operation as a result of receiving the wake-up command.

### BRIEF DESCRIPTION OF THE DRAWINGS

FIG. 1 is a diagram of an example battery pack.

FIG. 2 is a diagram of an example implementation associated with extended cell balancing using a telematics controller.

FIG. 3 is a flowchart of an example process associated with extended cell balancing using a telematics controller.

### DETAILED DESCRIPTION

This disclosure relates to cell balancing one or more battery cells in a battery pack, which is applicable to any machine that includes one or more batteries. For example, the machine may be an electric vehicle, an electric work machine (e.g., a compactor machine, a paving machine, a cold planer, a grading machine, a backhoe loader, a wheel loader, a harvester, an excavator, a motor grader, a skid steer loader, a tractor, and/or a dozer), or an energy storage system, among other examples. As used herein, the terms “battery cell,” “battery,” and “cell” may be used interchangeably.

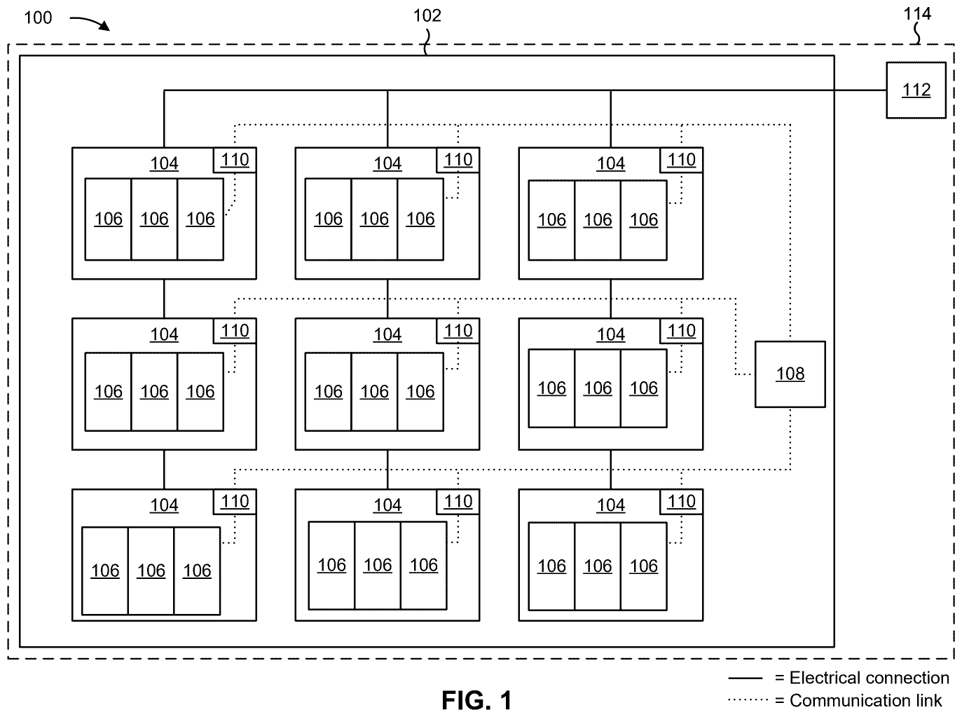

FIG. 1 is a diagram of an example battery pack 100. The battery pack 100 may include a battery pack housing 102, one or more battery modules 104, and one or more battery cells 106. The battery pack 100 includes a BMU 108 associated with storing information and/or controlling one or more operations associated with the battery pack 100. Each battery module 104 includes a cell monitoring unit (CMU) 110 associated with storing information and/or controlling one or more operations associated with the battery module 104.

The battery pack 100 may be associated with a component 112. The component 112 may be powered by the battery pack 100. For example, the component 112 can be a load that consumes energy provided by the battery pack 100, such as an electric motor, among other examples. As another example, the component 112 provides energy to the battery pack 100 (e.g., to be stored by the battery cells 106). In such examples, the component 112 may be a power generator, a solar energy system, and/or a wind energy system, among other examples. A machine 114 may include the battery pack 100 and the component 112 (e.g., an electric motor). For example, the battery pack 100 (e.g., one or more battery modules 104 thereof) may be electrically connected to the component 112. The machine 114 may be an electric vehicle (e.g., a car, a train, or a boat) or an electric work machine.

The battery pack housing 102 may include metal shielding (e.g., steel, aluminum, or the like) to protect elements (e.g., battery modules 104, battery cells 106, the BMU 108, the module controllers 110, wires, circuit boards, or the like) positioned within battery pack housing 102. Each battery module 104 includes one or more (e.g., a plurality of) battery cells 106 (e.g., positioned within a housing of the battery module 104). Battery cells 106 may be connected in series and/or in parallel within the battery module 104 (e.g., via terminal-to-busbar welds). Each battery cell 106 is associated with a chemistry type. The chemistry type may include lithium ion (Li-ion), nickel-metal hydride (NiMH), nickel cadmium (NiCd), lithium ion polymer (Li-ion polymer), lithium iron phosphate (LFP), and/or nickel manganese cobalt (NMC), among other examples.

The battery modules 104 may be arranged within the battery pack 100 in one or more strings. For example, the battery modules 104 are connected via electrical connections, as shown in FIG. 1. The electrical connections may be removable, such as via bolts and/or nuts at one or more terminals on housings of the battery modules 104. The battery modules 104 may be connected in series and/or in parallel. For example, a number of battery modules 104 may be connected in series to provide a particular voltage (e.g., to the component 112). Alternatively, a number of battery modules 104 may be connected in parallel to increase a current and/or a power output of the battery pack 100. The number of battery cells 106 included in each battery module 104, and the number of battery modules 104 included in the battery pack 100 (e.g., and the relative serial and/or parallel connections of the battery cells 106 and/or the battery modules 104) may be associated with the required output power and an intended use of the battery pack 100. For example, any number of battery cells 106 can be included in a battery module 104. Similarly, any number of battery modules 104 can be included in the battery pack 100.

The BMU 108 is communicatively connected (e.g., via a communication link) to each CMU 110. The BMU 108 may be associated with receiving, generating, storing, processing, providing, and/or routing information associated with the battery pack 100. The BMU 108 may also be referred to as a battery pack management device or system. The BMU 108 may communicate with the component 112 and/or a controller of the component 112, may control a start-up and/or shut-down procedure of the battery pack 100, may monitor a current and/or voltage of a string (e.g., of battery modules 104), and/or may monitor and/or control a current and/or voltage provided by the battery pack 100, among other examples. A CMU 110 may be associated with receiving, generating, storing, processing, providing, and/or routing information associated with a battery module 104. The CMU 110 may communicate with the BMU 108.

The BMU 108 and/or a CMU 110 may be associated with monitoring and/or determining a state of charge (SOC), a state of health (SOH), a depth of discharge (DOD), an output voltage, a temperature, and/or an internal resistance and impedance, among other examples, associated with a battery module 104 and/or associated with the battery pack 100. Additionally, or alternatively, the BMU 108 and/or the CMU 110 may be associated with monitoring, controlling, and/or reporting one or more parameters associated with battery cells 106. The one or more parameters may include cell voltages, temperatures, chemistry types, a cell energy throughput, a cell internal resistance, and/or a quantity of charge-discharge cycles of a battery module 104, among other examples.

As indicated above, FIG. 1 is provided as an example. Other examples may differ from what is described with regard to FIG. 1.

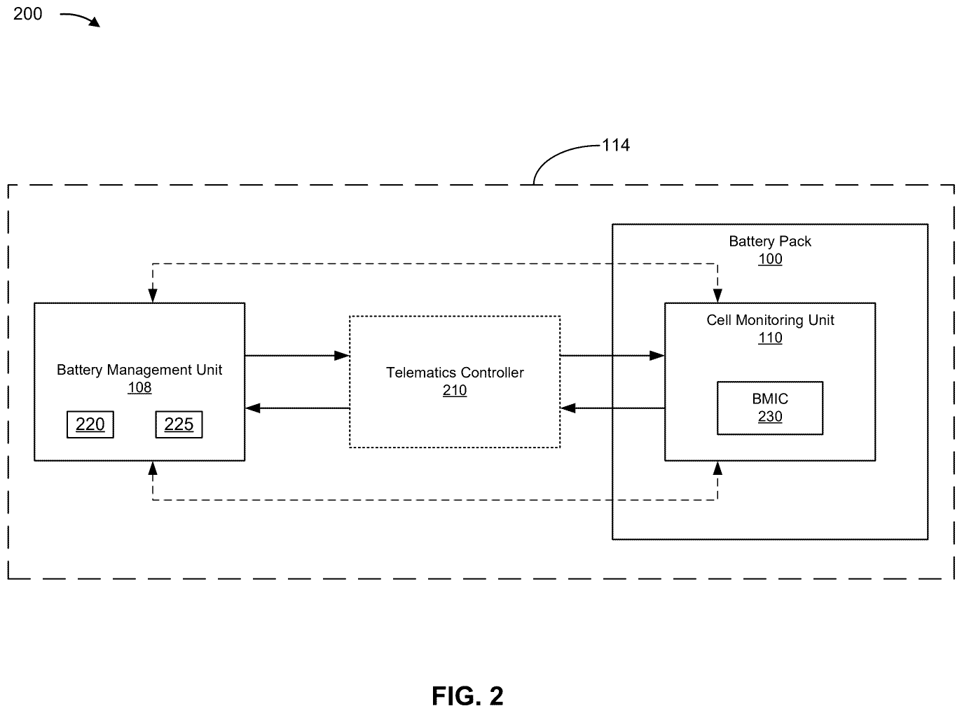

FIG. 2 is a diagram of an example implementation 200 associated with extended cell balancing using a telematics controller. As shown in FIG. 2, example implementation 200 includes a CMU 110, a telematics controller 210, and a BMU 108. The BMU 108, the CMU 110, and the telematics controller 210 may be part of a machine, such as the machine 114, discussed above with respect to FIG. 1. For example, the BMU 108, the CMU 110, the telematics controller 210, and/or a combination thereof, among other examples, may be part of a battery management system (BMS) of the machine.

The BMU 108 and CMU 110 may be in communication with one another via an isolation serial peripheral interface (isoSPI). For purposes of clarity, only one BMU 108 is shown in communication with one CMU 110. Multiple CMUs 110 may be in communication with the BMU 108 via the isoSPI, such as in an isoSPI daisy-chain ring arrangement. The telematics controller 210 may also be in communication with the BMU 108 and/or the CMU 110 via the isoSPI. The BMU 108 and the CMU 110 may be in direct communication with one another via the isoSPI. Alternatively, isoSPI communications between the BMU 108 and CMU 110 may pass through the telematics controller 210. In one arrangement, the telematics controller 210 may be in communication with the BMU 108 via a controller area network (CAN) bus.

The BMU 108 may be configured to communicate with one or more CMUs 110 and the telematics controller 210 via the isoSPI in a ring arrangement. With the isoSPI ring arrangement, the telematics controller 210 and the CMUs 110 may still be able to communicate when the BMU 108 is powered off. Likewise, if the telematics controller 210 were powered off, the isoSPI ring arrangement may permit the BMU 108 and CMUs 110 to continue to communicate with one another.

The CMU 110, which may be incorporated into the battery pack 100, as discussed above, may include any number of circuits, chips, or other electronic components that are individually or collectively configured to monitor the battery cells 106 and perform a cell balancing operation on one or more of the battery cells 106 in one or more battery packs 100. The cell balancing operation may include one or more actions taken to equalize the charges of multiple battery cells 106. The CMU 110 may include a battery controller (e.g., a battery monitoring integrated circuit (BMIC) 230) to perform the cell balancing operation. The BMIC 230 may be configured to perform passive balancing or active balancing. “Passive balancing” refers to using resistors to bleed excess charge from battery cells 106 that are fully charged. “Active balancing” refers to redistributing energy from battery cells 106 with higher charges to battery cells 106 with lower charges. Active balancing may involve capacitors, inductors, transformers, and/or a combination thereof, among other examples. The BMIC 230 may be configured to perform the cell balancing operation for a period of time (referred to herein as an “operating period”). The BMIC 230 may be configured to stop the cell balancing operation when the operating period has elapsed, even if the cell balancing operation has not been completed within the operating period.

The telematics controller 210 may include any number of circuits, chips, or other electronic components that are individually or collectively configured to perform various functions associated with the operation of the machine 114. For example, the telematics controller 210 may be configured to collect and/or transmit data; control certain operations of components of the machine 114; and/or output signals and/or alerts to a user via, for example, a user interface.

The telematics controller 210 may be configured to operate as a wake-up circuit for the BMU 108, the BMIC 230, and/or a combination thereof, among other examples. The telematics controller 210 may be configured to output a wake-up command to wake the BMU 108 from a sleep state, as discussed in greater detail below. The telematics controller 210 may be configured to output the wake-up command in accordance with a wake-up time interval. The wake-up time interval may be based on a duration of the operating period of the BMIC 230. For example, if the operating period is two hours, the wake-up time interval may be two hours.

The telematics controller 210 may be configured to output, to the BMU 108, a shutdown command after a delay time interval. The delay time interval may be associated with an amount of time after the telematics controller 210 outputs the wake-up signal to the BMU 108, an amount of time after the BMU 108 receives the wake-up command, and/or a combination thereof, among other examples. The shutdown signal may command the BMU 108 to enter the sleep state, and the delay time interval may be long enough (e.g., 5-10 minutes, for example) to give the BMU 108 enough time to power up from the sleep state, determine whether additional cell balancing is needed, and command the BMIC 230 to perform another cell balancing operation before returning to the sleep state.

The BMU 108 may include any number of circuits, chips, one or more memories 220, one or more processors 225, and/or other electronic components that are individually or collectively configured to perform, or facilitate the performance of, various operations associated with the battery packs 100 of the machine 114. For example, the BMU 108 may be configured to monitor the battery cells 106, facilitate balancing of the battery cells 106, estimate a battery state of charge (SoC), estimate a battery state of health (SoH), control charging and/or discharging of the battery cells 106, perform temperature management, detect faults associated with the battery cells 106, and/or communicate with other devices incorporated into the machine 114.

The BMU 108 may be configured to operate in a sleep state or an active state. The sleep state may be a low-power state where the operations of the BMU 108 are limited, to reduce power consumption. The active state may be a state where the BMU 108 can fully perform operations, such as those discussed above. The BMU 108 may be configured to enter the sleep state from the active state by setting a shutdown flag. The BMU 108 may set the shutdown flag as a result of receiving the shutdown command from the telematics controller 210, as discussed above. The BMU 108 may be configured to enter the active state from the sleep state after a period of time has elapsed or in response to one or more signals, such as the wake-up command output by the telematics controller 210. As discussed in greater detail below, the BMU 108 may be configured to enter the sleep state after commanding the BMIC 230 to perform a first cell balancing operation. The BMU 108 may be configured to transition from the sleep state to the active state before the BMU 108 commands the BMIC 230 to perform a second cell balancing operation.

The BMU 108 may be configured to output signals to, and receive signals from, other components of the machine 114. For example, the BMU 108 may be configured to output commands that cause the BMIC 230 to perform a cell balancing operation on one or more battery cells 106 in a battery pack 100. The BMU 108 may be further configured to output, to the telematics controller 210, a wake-up time interval, and receive, from the telematics controller 210, the wake-up command to wake the BMU 108 from the sleep state. The BMU 108 may be further configured to receive, from the telematics controller 210 and after the delay time interval, the shutdown command that causes the BMU 108 to enter the sleep state. As discussed above, the delay time interval may be associated with an amount of time after the BMU 108 receives the wake-up command, an amount of time since the telematics controller 210 transmitted the wake-up command, and/or a combination thereof, among other examples. Further, the delay time interval may be long enough to give the BMU 108 enough time to power up from the sleep state, determine whether additional cell balancing is needed, and command the BMIC 230 to perform another cell balancing operation before returning to the sleep state. Accordingly, the BMU 108 may be configured to command the BMIC 230 to perform a first cell balancing operation, enter the sleep state, and command the BMIC 230 to perform a second cell balancing operation after waking from the sleep state (e.g., after the BMU 108 transitions from the sleep state to an active state). Further, the BMU 108 may be configured to transmit the wake-up time interval, to the telematics controller 210, before the BMU 108 enters the sleep state.

The BMU 108 may be configured to output, to the BMIC 230, an extended balancing mode enable request to, for example, cause the BMIC 230 to operate in an extended cell balancing mode. The extended balancing mode enable request may include one or more parameters associated with one or more cell balancing operations to be performed while the BMIC 230 is operating in the extended cell balancing mode and while the BMU 108 is in the sleep state. The one or more parameters may include a battery balancing time limit (e.g., an amount of time that the BMIC 230 can perform one or more cell balancing operations), an under voltage value (e.g., a target voltage for the battery cells 106 included in one or more of the cell balancing operations), a duty cycle (e.g., a pulse-width modulation (PWM) duty cycle) associated with one or more of the battery cells 106 included in one or more of the cell balancing operations, and/or a combination thereof, among other examples.

The BMU 108 may be configured to transmit, and the BMIC 230 may be configured to receive, the extended balancing mode enable request and/or the one or more parameters while the BMIC 230 is operating in a standby mode and before the BMU 108 enters the sleep state. When a triggering event occurs (e.g., the BMIC 230 no longer receives isoSPI messages from the BMU 108 or the telematics controller 210), the BMIC 230 may be configured to transition from the standby mode to the extended cell balancing mode. When operating in the extended cell balancing mode, the BMIC 230 may be configured to perform a cell balancing operation (e.g., a passive cell balancing operation or an active cell balancing operation, as discussed above). The BMIC 230 may be configured to continue to perform one or more cell balancing operations until the battery balancing time limit has elapsed, until the battery cells 106 are sufficiently balanced, and/or a combination thereof, among other examples. The BMIC 230 may be configured to enter a sleep mode when, for example, the balancing time limit has been reached, and the BMIC 230 may be configured to remain in the sleep mode until the BMIC 230 receives, for example, an isoSPI message output by the BMU 108, the telematics controller 210, and/or a combination thereof, among other examples. Upon receipt of the isoSPI message, the BMIC 230 may return to the standby mode, as discussed above. Further, when operating in the extended cell balancing mode, the BMIC 230 may be configured to enter the standby mode upon receipt of an isoSPI message output by the BMU 108 and/or the telematics controller 210.

In response to receiving the wake-up command output by the telematics controller 210, the BMU 108 may be configured to transition from the sleep state to the active state, as discussed above. Further, in response to receiving the wake-up command, the BMU 108 may be configured to output, to the BMIC 230, an extended balancing mode disable request and updated parameters such as an updated under voltage value (e.g., an updated voltage based on a safety limit rather than a target voltage for cell balancing), an updated duty cycle (e.g., a value of 1) associated with one or more of the battery cells 106 included in one or more of the cell balancing operations, an updated battery balancing time limit (e.g., 0 seconds), and/or a combination thereof, among other examples. The BMIC 230 may receive the extended balancing mode disable request and the updated parameters and, in response, enter the standby mode.

The telematics controller 210 may be configured to output signals, such as the commands to perform one or more cell balancing operations, directly to the BMIC 230. By doing so, the BMIC 230 can continue to perform cell balancing operations despite the battery balancing time limit and without waking the BMU 108 from the sleep state.

Accordingly, the BMIC 230 may continue to perform multiple cell balancing operations (e.g., an initial cell balancing operation and one or more subsequent cell balancing operations) while allowing the BMU 108 to occasionally enter a sleep state. Without the wake-up command, the BMU 108 would stay in the sleep state at the end of the battery balancing time limit, and therefore be unable to initiate the one or more subsequent cell balancing operations. Therefore, by having the telematics controller 210 output the wake-up command to the BMU 108 or to the BMIC 230, the BMIC 230 can be commanded (by the BMU 108 or the telematics controller 210) to perform one or more subsequent cell balancing operations, especially if the initial cell balancing operation was unable to fully balance the charges of one or more of the battery cells 106 in a battery pack 100.

As indicated above, FIG. 2 is provided as an example. Other examples may differ from what is described with regard to FIG. 2.

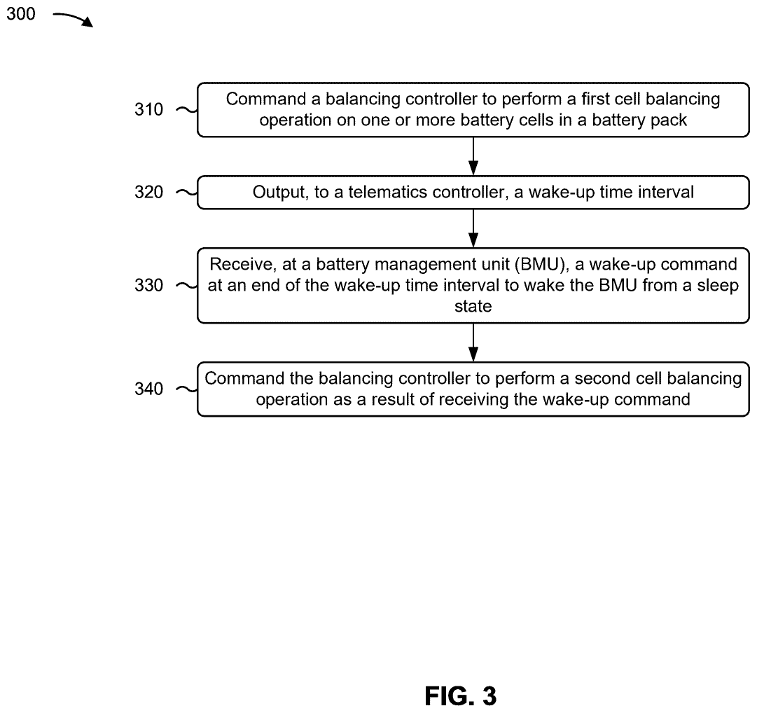

FIG. 3 is a flowchart of an example process 300 associated with extended cell balancing using a telematics controller 210. One or more process blocks of FIG. 3 may be performed by a BMS (e.g., by the BMU 108). Additionally, or alternatively, one or more process blocks of FIG. 3 may be performed by another device or a group of devices separate from or including the BMU 108, such as another device or component that is internal or external to the machine 114. For example, one or more process blocks of FIG. 3 may be performed by a telematics controller (e.g., telematics controller 210).

As shown in FIG. 3, process 300 may include commanding a BMIC 230 to perform a first cell balancing operation on one or more battery cells 106 in a battery pack 100 (block 310). For example, the BMU 108 may command a BMIC 230 to perform a first cell balancing operation on one or more battery cells 106 in a battery pack 100, as described above.

As further shown in FIG. 3, process 300 may include outputting, to a telematics controller 210, a wake-up time interval (block 320). For example, the BMU 108 may output, to a telematics controller 210, a wake-up time interval, as described above.

As further shown in FIG. 3, process 300 may include receiving, at a BMU 108, a wake-up command at an end of the wake-up time interval to wake the BMU 108 from a sleep state (block 330). For example, the BMU 108 may receive a wake-up command at an end of the wake-up time interval to wake the BMU 108 from a sleep state, as described above. The wake-up time interval may be associated with one or more battery characteristics. The one or more battery characteristics may include one or more of a battery aging value, a battery parasitic drain value, a battery state-of-charge, or a battery temperature.

As further shown in FIG. 3, process 300 may include commanding the BMIC 230 to perform a second cell balancing operation as a result of receiving the wake-up command (block 340). For example, the BMU 108 may command the BMIC 230 to perform a second cell balancing operation as a result of receiving the wake-up command, as described above.

Process 300 may include receiving, from the telematics controller 210 and after a delay time interval, a shutdown command at the BMU 108. The delay time interval may be associated with an amount of time after the BMU 108 receives the wake-up command.

Process 300 may include setting a shutdown flag at the BMU 108 as a result of receiving the shutdown command. Process 300 may include outputting, to the BMIC 230, an extended balancing mode enable request. Process 300 may include outputting one or more parameters to the BMIC 230, the one or more parameters being associated with the BMIC 230 operating in an extended cell balancing mode. The one or more parameters may include a battery balancing time limit. Receiving the wake-up command may occur in accordance with the battery balancing time limit. The one or more parameters may include one or more of an under voltage value, or a duty cycle.

Process 300 may include entering a sleep state after commanding the BMIC 230 to perform the first cell balancing operation and before commanding the BMIC 230 to perform the second cell balancing operation.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

### INDUSTRIAL APPLICABILITY

The foregoing disclosure may be applicable to any machine that includes one or more batteries. For example, as discussed above, the machine may be an electric vehicle, an electric work machine (e.g., a compactor machine, a paving machine, a cold planer, a grading machine, a backhoe loader, a wheel loader, a harvester, an excavator, a motor grader, a skid steer loader, a tractor, and/or a dozer), or an energy storage system, among other examples.

The concepts discussed above may allow the balancing controller (e.g., the BMIC) to continue to perform multiple cell balancing operations (e.g., an initial cell balancing operation and one or more subsequent cell balancing operations) while also allowing the BMU to occasionally enter a sleep state. With the wake-up command output by the telematics controller, the BMU can transition from the sleep state to the active state at the end of the battery balancing time limit, determine whether additional cell balancing should be performed, and if so, command the balancing controller to initiate one or more subsequent cell balancing operations before the BMU returns to the sleep state. Accordingly, the balancing controller may continue to balance the charge of multiple battery cells in a battery pack despite being hardcoded with an insufficient battery balancing time limit (e.g., a time limit that does not give the balancing controller enough time to fully balance the charges of the battery cells). Further, by having the telematics controller output the wake-up command to the BMU or to the balancing controller, the balancing controller may perform more cell balancing operations, resulting in more efficient energy usage that can prolong the lives of the battery packs.

What is claimed is:

1. A method, comprising:
commanding a balancing controller to perform a first cell balancing operation on one or more battery cells in a battery pack;
outputting, to a telematics controller, a wake-up time interval;
receiving, at a battery management unit (BMU), a wake-up command at an end of the wake-up time interval to wake the BMU from a sleep state; and
commanding the balancing controller to perform a second cell balancing operation as a result of receiving the wake-up command.

2. The method of claim 1, further comprising receiving, from the telematics controller and after a delay time interval, a shutdown command at the BMU,
wherein the delay time interval is associated with an amount of time after the BMU receives the wake-up command.

3. The method of claim 2, further comprising setting a shutdown flag at the BMU as a result of receiving the shutdown command.

4. The method of claim 1, further comprising outputting, to the balancing controller, an extended balancing mode enable request.

5. The method of claim 1, further comprising:
outputting one or more parameters to the balancing controller,
the one or more parameters being associated with the balancing controller operating in an extended cell balancing mode.

6. The method of claim 1, further comprising entering a sleep state after commanding the balancing controller to perform the first cell balancing operation and before commanding the balancing controller to perform the second cell balancing operation.

7. A machine, comprising:
a plurality of battery packs, each having a plurality of battery cells;
a telematics controller configured to output a wake-up command after a wake-up time interval; and
a balancing controller configured to perform a first cell balancing operation on one or more of the plurality of battery cells of one or more of the plurality of battery packs and to perform a second cell balancing operation as a result of the telematics controller outputting the wake-up command.

8. The machine of claim 7, further comprising a battery management unit (BMU) in communication with the telematics controller and the balancing controller, wherein the BMU is configured to:
command the balancing controller to perform the first cell balancing operation;
enter a sleep state; and
command the balancing controller to perform the second cell balancing operation after waking from the sleep state.

9. The machine of claim 8, wherein the BMU is configured to set the wake-up time interval and output the wake-up time interval to the telematics controller before entering the sleep state.

10. The machine of claim 8, wherein one of the BMU or the balancing controller is configured to receive the wake-up command at an end of the wake-up time interval.

11. The machine of claim 8, wherein the telematics controller is further configured to output, to the BMU, a shutdown command after a delay time interval.

12. The machine of claim 11, wherein the delay time interval is an amount of time after the telematics controller outputs the wake-up command.

13. The machine of claim 11, wherein, to enter the sleep state, the BMU is configured to set a shutdown flag as a result of receiving the shutdown command.

14. The machine of claim 8, wherein the BMU is further configured to output, to the balancing controller, an extended balancing mode enable request before entering the sleep state.

15. The machine of claim 8, wherein the BMU is further configured to output one or more parameters to the balancing controller, the one or more parameters being associated with the balancing controller operating in an extended cell balancing mode.

16. The machine of claim 15, wherein the one or more parameters include a battery balancing time limit.

17. The machine of claim 16, wherein the telematics controller is configured to output, to the BMS, the wake-up command in accordance with the battery balancing time limit.

18. The machine of claim 15, wherein the one or more parameters include one or more of an under voltage value, or a duty cycle.

19. A battery management unit (BMU), comprising:
one or more memories; and
one or more processors, communicatively coupled to the one or more memories, configured to:
command a balancing controller to perform a first cell balancing operation on one or more battery cells in a battery pack;
set a wake-up time interval;
enter a sleep state;
receive a wake-up command at an end of the wake-up time interval; and
command the balancing controller to perform a second cell balancing operation as a result of receiving the wake-up command.

20. The BMU of claim 19, wherein the one or more processors are further configured to:
receive, after a delay time interval, a shutdown command,
wherein the delay time interval is associated with an amount of time after receiving the wake-up command, and
wherein the one or more processors, to enter the sleep state, are further configured to set a shutdown flag as a result of receiving the shutdown command.
